(19) United States
(12) Patent Application Publication
(10) Pub. No.: US 2005/0151422 A1
(43) Pub. Date: Jul. 14, 2005

(54) Universal serial bus connector in a vehicle

(76) Inventor: Daniel A. Gilmour, West Hartford, CT (US)

Correspondence Address: CANTOR COLBURN LLP, 55 Griffin Road South, Bloomfield, CT, 06002, US

(21) Appl. No.: 10/755,068

(22) Filed: Jan. 8, 2004

(51) Int. Cl. B60L 3/00

(52) U.S. Cl. 307/10.1

(57) ABSTRACT

An electronic charging apparatus incorporates a universal serial bus connector for providing a location to plug in a portable electronic device in a vehicle. The electronic device can be plugged in for utilization and/or for recharging using the vehicular power source. The universal serial bus connector may be coupled to the vehicle's audio system such that sound from the electronic device can be heard through the speaker system.

### BACKGROUND OF THE INVENTION

This invention relates to vehicles, and more particularly relates to an enhancement to a method and system enabling the use and recharging of a variety of peripheral devices within a vehicle.

Recent advances in portable electronics have prompted the users of such electronic devices to carry their devices with them wherever they go. While the portability of such devices allows them to be carried into an automobile or other drivable vehicle, actually using these devices while driving can sometimes be a challenge. Cell phones, for instance, are notorious for distracting drivers while in use. Holding and talking into a cell phone while driving with one hand has been a source of controversy and prompted many cell phone users to arrange complicated hands-free systems or microphones in their cars, which varying success. Many drivers also skip from radio station to radio station looking for the perfect song, while their MP3 players hold all their favorites in a handy portable device, but without the phenomenal acoustics provided in automobile stereo systems. Thus, the driver must either sacrifice sound quality to use their MP3 player, surf the radio stations, or listen to CD's. Additionally, some electronic devices which run on rechargeable batteries are at risk of losing their charge while in use during long drives.

Meanwhile, while at home, the owners of electronic devices have been able to take advantage of their home computers and the Universal Serial Bus (“USB”), which has become a widely used standard for connection of computers to a myriad of electronic devices such as personal digital assistants (“PDA's”), digital cameras, MP3 players, USB thumb drives, solid state memory chip readers, mouse, keyboards, printers, fax machines, scanners, cell phones, small lights, etc. Laptop computers, desktop computers, wearable computers, and PDA's are commonly manufactured with USB ports in order to take advantage of the variety of peripheral devices which are built around that architecture. Many USB peripheral devices, such as printers, scanners, mice, joysticks, digital cameras, web cams, modems, speakers, phones, etc., come with their own built in cable, and the cable has an “A” connection on it. The “A” connector is a connector which heads upstream towards the computer. A USB port on a computer is designed to accept an “A” connector. If the USB peripheral device does not have a built in cable with the “A” connector, then the device has a socket on it that accepts a USB “B” connector. The “B” connector is a connector which heads downstream and connects to an individual device. Since the USB port on the computer only accepts the “A” connector and not the “B” connector, plugging the cable into either or both the computer and the peripheral device is nearly error-proof.

FIG. 1 shows a partial view of a prior art computer 100, such as a portable computing device as shown, including a pair of USB ports 102. Desktop computers as well as PDA's are also designed with USB ports as shown, and may include only one USB port or several USB ports. FIG. 2 shows a prior art USB plug 104, which is an “A” type connector, designed for insertion into USB port 102 of a computer 100. The USB plug 104 is typically located at the end of a USB cable extending from a peripheral device such as a printer, scanner, mouse, joystick, digital camera, web cam, modem, speaker, etc. While the term USB port 102 and USB plug 104 are used, the port may also be a USB 2.0 port and the plug may also be a USB 2.0 plug. USB 2.0 was released in 2000 and supports a bus speed 40 times faster than USB 1.x.

The USB standard provides that in addition to carrying data bi-directionally, a USB cable must also supply electrical power unidirectionally. The power and data passes through pre-defined terminals or pin-outs provided on standardized plugs on each free end of the USB cable. The plugs are defined in the standard as having different forms at upstream and downstream ends. Each plug can mate only with a complementary shaped receptacle or port provided in the USB device to be connected. Thus, the standard ensures that a cable can only be connected to provide power from an upstream port to a downstream port. Many of the peripheral devices described above receive all the power they need to operate directly from the USB connection. Some battery powered devices recharge their batteries through a USB connection. Therefore, the plug 104 and powered USB port 102 also may include terminals or pin-outs for providing power in a direction from the USB port 102 to the plug 104 for recharging rechargeable batteries contained within the peripheral device. Thus, the peripheral device can be recharged by simply connecting the plug 104 into the port 102.

### BRIEF SUMMARY OF THE INVENTION

The above discussed and other drawbacks and deficiencies are overcome or alleviated by an electronic charging apparatus including a vehicular mounted electronic circuit and a universal serial bus connector coupled to the electronic circuit, wherein the connector is operable to supply electrical power to electronic devices.

In an alternate embodiment, a method for charging a battery powered device includes coupling the battery powered device electronically to a universal serial bus connector of an electronic charging apparatus, supplying electrical power for charging the battery powered device from an automobile power source through the universal serial bus connector, and controlling the electrical power for charging to an appropriate power level by means of circuitry resident in the electronic charging apparatus.

In an alternate embodiment, a vehicle includes a vehicular power source and a universal serial bus port for receiving a universal serial bus plug of a portable electronic device, the port coupled to the power source.

The above discussed and other features and advantages of the present invention will be appreciated and understood by those skilled in the art from the following description and drawings.

### BRIEF DESCRIPTION OF THE DRAWINGS

Referring to the exemplary drawings wherein like elements are numbered alike in the several FIGS.:

FIG. 1 is a perspective view of a prior art computing device;

FIG. 2 is a perspective view of a prior art USB plug;

FIG. 3 is a partial block diagram of a vehicle incorporating a USB system;

FIG. 4 is a front plan view of a stereo having a USB port;

FIG. 5 is a partial block diagram of the stereo of FIG. 4 and its associated components from the vehicle of FIG. 3;

FIG. 6 is a side plan view of a stereo having an alternate USB port;

FIG. 7 is a flowchart of a process for device connection notification; and,

FIG. 8 is a partial block diagram of a vehicle including an electronic charging apparatus.

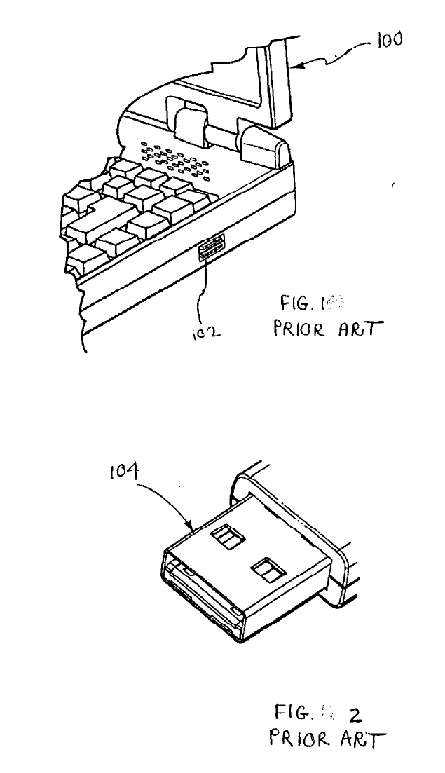

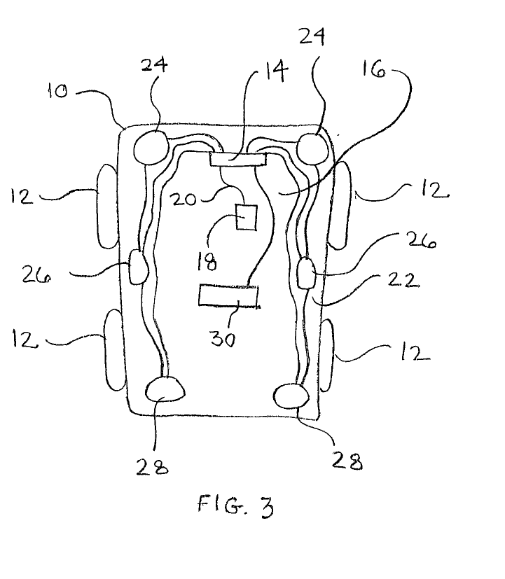

### DETAILED DESCRIPTION OF THE PREFERRED EMBODIMENTS

Referring now to FIG. 3, a vehicle 10 is shown including drivable elements 12. The vehicle 10 may be an automobile as shown, or may alternatively be a van, bus, truck, recreational vehicle (“RV”), boat, motorcycle, ski mobile, train, plane, or any other vehicle containing a stereo receiver 14. Also, while a vehicle 10 is shown, it should also be understood that the stereo receiver 14 could be located in alternate locations for use as desired by the end user. Additionally, while the drivable elements 12 may be four wheels as shown, the drivable elements may be any number of wheels, skis, propellers, etc. employed for turning a vehicle in a desired direction, and the drivable elements 12 need not be used for the system 16 to function.

As will be further described below, a USB port is incorporated in the stereo 14. The system 16 allows for two way data communication and one way power transmission from the stereo 14 to a portable data storage and/or communication device 18. The system 16 may be incorporated into any car stereo 14 or other dedicated stereo that will permit portable electronic devices 18 to be recharged without a special dedicated adapter cord, permit any mobile phone to plug in for hands free operation in any vehicle, and allow for audio and video files to be fed into the automobile or other vehicle 10 through the standardized USB connection.

Additionally, while the system 16 is specifically described in connection with a stereo 14, it should be understood that in its simplest form, the system 16 may include a USB connection, such as a USB port, mounted conveniently within the vehicle 10. An electronic circuit coupled to the USB port may control the recharging of batteries of the electronic devices 18. Thus, in this form, an electronic charging apparatus is provided.

The system 16 could be used to eliminate the need to carry a bulky product specific charger/transformer. The user would only have to plug in a small USB cable 20 from the device 18 to the USB port in the stereo 14 or electronic charging apparatus, and then the device 18 would be recharging.

The user may carry a music library into the vehicle 10, and be able to play such music in any vehicle 10 which includes the USB port in the stereo 14. A device 18 having the MP3 files on it, such as an IPOD brand player or other MP3 player, or a memory card, or even a cell phone, may be plugged into the USB port of the vehicle stereo 14 and the selection may then appear on the stereo's display. The user may then navigate using the buttons of the stereo 14 to play the desired selection. The buttons may be on a touch sensitive display or next to the display such that a button's function is displayed on the display and is determined by the device connected via the USB port. The user may listen to the selection through the vehicle's audio system 22, which may, by example only, include front speakers 24, side speakers 26, and/or rear speakers 28, which are connected to the stereo 14 through any known methods of sound communication, for instance by wires connecting each speaker individually to the stereo 14, or to intermediate amplifiers, not shown, for maximizing the sound performance in a specific type of vehicle.

A video collection may also employ the USB connection system shown in FIG. 3 by inserting an MPEG2, MPEG4, AVI or other format movie file into the automobile's stereo 14 via a device 18, having the video files on it such as the Archos MP4, the Pogo Flipster MP4 players, a hard drive, or a memory card, or even a cell phone, may be plugged into the USB port of the vehicle stereo 14 or audio/video system, and one can then watch the movie file on the automobile's video monitor(s) 30 and listen to the movie file through either the audio system 22 or through ear phones (not shown) plugged into the audio/video system.

The convenience of hands-free speakerphone may also be provided in the vehicle 10 by plugging a cell phone as the peripheral device 18 into the USB port built into the stereo 14. When a telephone call is received on the cell phone that is plugged into the stereo 14, the stereo 14 may automatically mute the music or radio signal being received and switch into speakerphone mode. Thus, the caller's voice may be transmitted through the audio system 22, allowing for superb clarity of the caller's voice without having to hold the phone to an ear and without having to wear a headset. A microphone may be clipped to a sun visor for convenience or be integrated as art of the vehicle's audio/video system. Additionally, for phones and users who pay for caller ID service, the caller's phone number and/or name may appear on a display on the stereo 14.

Other devices 18 may also advantageously be recharged and/or utilized through the USB port in the stereo 14. These devices 18 may include, but are not limited to personal digital assistants (“PDA's”), digital cameras, MP3 players, MP4 players, USB thumb drives, solid state memory chip readers, printers, fax machines, scanners, cell phones, global positioning system, small lights, electric razors, etc.

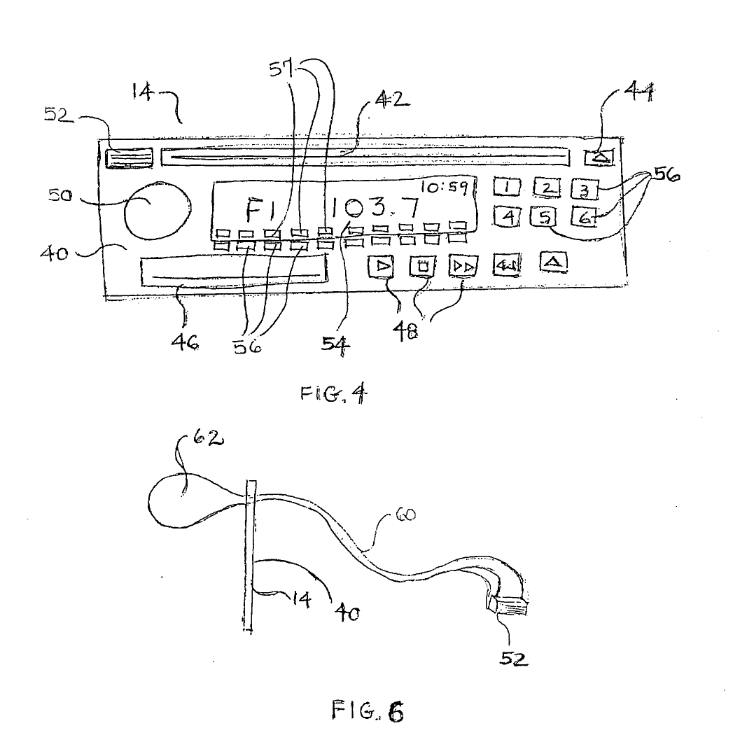

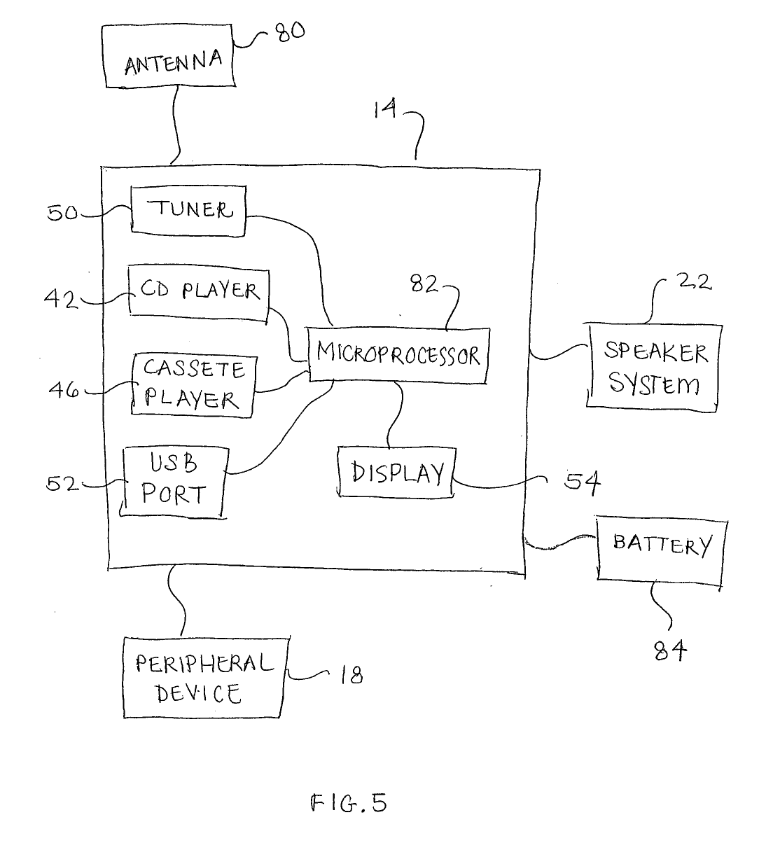

Turning now to FIG. 4, embodiments of the stereo 14 are shown. It should be understood that stereos may come in a variety of shapes and sizes and may accommodate a nearly limitless number of functions and arrangements and therefore the following description of stereo 14 should be construed as exemplary only, and not as limiting to the system 16. Furthermore, as previously described, the system 16 may include simply the USB port for functioning as an electronic charging apparatus. The stereo 14 may include a faceplate 40 that is visible from within the vehicle 10. The stereo 14 may further include a CD player 42 with eject button 44, an audio cassette player 46 with function buttons 48, and a station dialer 50 for selecting an AM or FM radio station. The stereo 14 may be connected to an antenna 80, shown in FIG. 5, to receive radio waves. The stereo 14 may further include a USB port 52 for accepting a plug from USB cable 20 extending from a peripheral device 18. While the term USB port 52 and USB cable 20 are used, it should be understood that the port 52 may also be a USB 2.0 port and the plug from cable 20 may also be a USB 2.0 plug. It is further within the scope of this invention to incorporate any update of the USB specification, as well as any other plug/port configuration usable within the computer environment. Also, while only one port 52 is shown, it is also within the scope of this invention to incorporate two or more USB ports 52 for simultaneously accommodating more than one USB enabled peripheral device. It should be understood that the USB port 52 permits two way transmission of data and that the USB port 52 is operable to supply electrical power to a connected device 18.

Further in the stereo 14, a multi-function digital display 54 may display information relating to any of the CD player 42, audio cassette player 46, or the station dialer 50, or any information relating to a peripheral device 18 plugged into the USB port 52. The display 54 may also display other information such as, but not limited to, time, outside temperature, miles to empty, direction of travel, etc. The display 54 may be directed by a stereo microprocessor 82 shown in FIG. 5 that receives and processes information from components 50, 42, 46, and 52. It should thus be understood that the stereo 14 includes an electronic circuit that facilitates data receipt and transmission. Selection buttons 56 may be used for a variety of purposes depending upon which function (i.e. CD player, audio cassette player, AM/FM receiver, or USB port) is being employed. That is, the selection buttons 56 may be used to select a track on a CD or cassette player, select a preset radio station, or toggle between operations of a peripheral device 18. Information from these buttons 56 may also be processed by the microprocessor 82, particularly for when the operations of the peripheral device 18 are being selected. Buttons 56 may be numbered buttons on a side of the display 54 or may be on a touch sensitive display or next to the display 54 such that the button's function is displayed on the display 54 at locations 57. Differing functions would be determined by the device 18 connected via the USB port 52. With the buttons 56 positioned adjacent the display 54, areas 57 on the display may correlate with each button 56 which enable the button's redefined functions, based on the device 18, to be displayed near the button.

As further shown in FIG. 5, the stereo 14 is connected to the battery 84 or alternative power source of the car 10. When the USB port 52 is accessed by a peripheral device 18, the peripheral device 18 may automatically begin recharging via the battery 18 through the USB unidirectional powering capabilities. Thus, the stereo 14 includes an electronic circuit which couples the USB port 52 to a source of electrical power, and the electronic circuit is enabled to control recharging of batteries within the electronic device or devices 18. The electronic circuit may include an electronic data hub where the electronic circuit is operable to control the recharging of multiple battery powered devices 18. It should be further understood that the electrical power for charging is controlled to an appropriate power level by means of circuitry resident in the stereo 14.

While the USB port 52 is shown in FIG. 4 as a port embedded within the faceplate 40, the female USB port 52 may instead be connected to the vehicle 10 via a retractable cord 60 as shown in FIG. 6. The retractable cord 60 may extend at the selected length from the faceplate 40. The portion of the cord 60 which is not needed may sit within cavity 62 behind the faceplate 40. If the cord 60 is not needed, then the cord 60 may be tugged slightly to have it retract all the way into the cavity 62 such that the port 52 is nearly flush with the faceplate 40, as shown in FIG. 4. Since some devices 18 may have a short cable 20, or may have the USB plug directly associated with the device 18, having a retractable cable 60 provides greater flexibility as to the location of the port 52, allowing devices 18 to plug into the port 52 without sticking out from the dash of the vehicle 10. Since this provides greater flexibility for locating the device 18, the movable port 52 may reduce the damage that could result from something accidentally hitting the device 18.

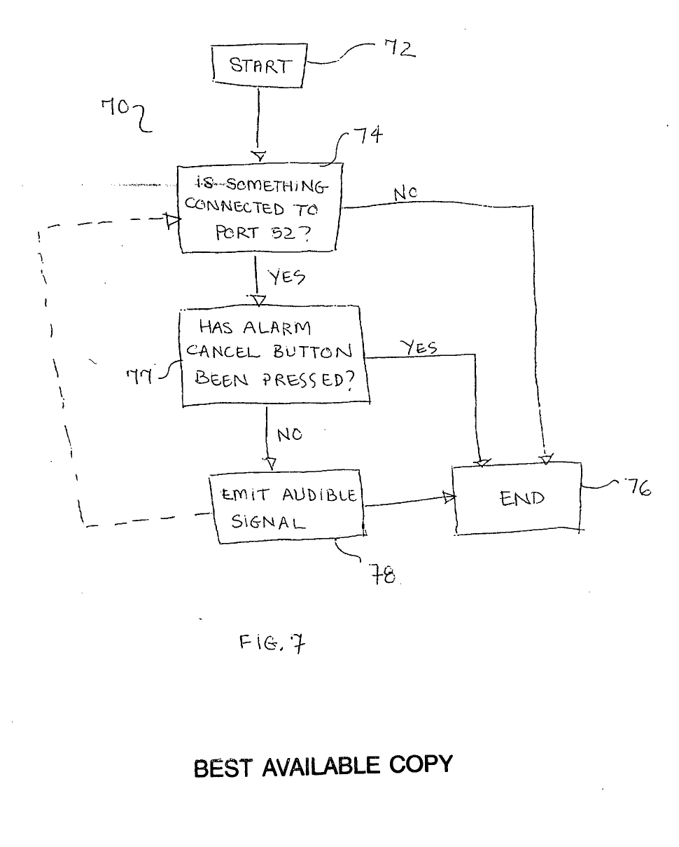

As shown in FIG. 7, the vehicle audio system 22 may emit an audible alert if the ignition is turned off while a device 18 is still plugged into the female USB port 52. This may help remind the user to not leave their device 18 in the vehicle 10, which would be particularly unfortunate if the vehicle 10 is a rental vehicle. Additionally, or in place of the audible alert when the ignition is turned off, the vehicle audio system may emit an audible alert if a door of the vehicle 10 is opened while a device 18 is still plugged into the female USB port 52. In either case, the vehicle's microprocessor may start the device presence indicating process 70 at start 72 when either a door is opened or the ignition is turned off. At block 74, the process determines whether or not something is connected to port 52. If not, the process ends at block 76. If yes, the process 70 may then determine if a user has pressed an alarm cancel button as shown in block 77. If the alarm cancel button has been pressed, then the process may end at block 76. However, if the alarm cancel button has not been pressed, then the process emits an audible signal at block 78. The process may then end at block 76. Alternatively, the process 70 may loop back to the inquiry at block 74 to determine again whether or not the device has been removed from the port 52. If the user was prompted by the audible signal to remove the device 18, then the process 70 would end at block 76. If the device 18 is still not removed and if the alarm cancel button still has not been pressed, then another audible signal may be emitted at block 74 and may continue until either the device 18 is removed, the door is closed, or after a predetermined time period, or until the alarm cancel button is pushed on the stereo 14. The alarm cancel button may be any one of the buttons 56 and may be indicated as the alarm cancel button by indicia displayed on the display 54 within a correlating area 57. Alternatively, one of the buttons 56, or another button not shown, may be distinctively labeled as an alarm cancel button.

FIG. 8 shows a USB port incorporated into the vehicle 10, but not necessarily into a stereo 14. That is, an electronic charging apparatus 90 may be provided in the vehicle 10 which allows the connection of peripheral devices 18 as previously described to a USB port 52, and which includes an electronic circuit which controls the electrical power to an appropriate power level for charging. The electronic charging apparatus 90 may or may not be connected to a vehicle's speaker system 22. Thus, the electronic charging apparatus 90 is similar to the stereo 14, but need not include the CD player 42, cassette player 46, tuner 50, and display 54, and need not be connected to antenna 80. Furthermore, the electronic charging apparatus 90 may either be incorporated into any embodiment of a stereo 14 or may be used separately within the vehicle 10.

Thus, a vehicular stereo 14 and an electronic charging apparatus 90 has been described which incorporates a USB port 52 for providing a location to plug in portable electronic devices 18 having a USB plug. The electronic devices 18 can be plugged in for utilization and/or for recharging. The incorporation of the USB port 52 into the vehicular stereo 14 allows the devices 18 to take advantage of the vehicle's audio and video system 22.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. An electronic charging apparatus, comprising:
a vehicular mounted electronic circuit; and,
a universal serial bus connector coupled to the electronic circuit, wherein the connector is operable to supply electrical power to electronic devices.

2. The apparatus of claim 1, wherein said electronic circuit is enabled to control recharging of batteries of said electronic devices.

3. The apparatus of claim 1 wherein said apparatus is housed within a stereo system.

4. The apparatus of claim 1 wherein the universal serial bus connector is female.

5. The apparatus of claim 1 wherein there is a plurality of universal serial bus connectors.

6. The apparatus of claim 1 wherein the electronic circuit comprises an electronic data hub.

7. The apparatus of claim 1 wherein the universal serial bus connector is provided on a retractable cord which is extendable from the apparatus and retractable into the apparatus.

8. The apparatus of claim 1 wherein the electronic circuit is connected to a vehicular battery.

9. A method for charging a battery powered device, comprising:
coupling said battery powered device electronically to a universal serial bus connector of an electronic charging apparatus;
supplying electrical power for charging said battery powered device from an automobile power source through said universal serial bus connector; and,
controlling the electrical power for charging to an appropriate power level by means of circuitry resident in said electronic charging apparatus.

10. The method of claim 9, further comprising communicating data to and from the battery powered device over the universal serial bus connector.

11. The method of claim 10, wherein the battery powered device is a cell phone, further comprising employing an automobile sound system as a speaker for the phone.

12. The method of claim 10, wherein communicating data comprises communicating audio files over an automobile sound system.

13. The method of claim 10, wherein communicating data comprises communicating video files over an automobile video entertainment system.

14. The method of claim 9 further comprising detecting an ignition status as off or a door as open and emitting an audible alert if the battery powered device is connected to the universal serial bus connector.

15. A vehicle, the vehicle comprising:
a vehicular power source; and,
a universal serial bus port for receiving a universal serial bus plug of a portable electronic device, the port coupled to the power source.

16. The vehicle of claim 15 further comprising a speaker, the universal serial bus port electronically coupled to the speaker, wherein audio from the portable electronic device is audible through the speaker.

17. The vehicle of claim 15 wherein the vehicle is an automobile.

18. The vehicle of claim 15 wherein the universal serial bus port is provided in a stereo system.

19. The vehicle of claim 15 wherein the universal serial bus connector is provided on a retractable cord, wherein the cord is retractable into the vehicle.

20. The vehicle of claim 15 further comprising the portable electronic device plugged into the universal serial bus port, wherein the portable electronic device is charged via the electronic circuit and wherein sound from the portable electronic device is transferred through a vehicular speaker system.
